(19) United States
(12) Patent Application Publication
(10) Pub. No.: US 2022/0132802 A1
(43) Pub. Date: May 5, 2022

(54) Scratching Post Wrap Apparatus

(71) Applicants: Paul Mora, Williamsburg, NM (US); William Glaze, Tucson, AZ (US)

(72) Inventors: Paul Mora, Williamsburg, NM (US); William Glaze, Tucson, AZ (US)

(21) Appl. No.: 17/089,349

(22) Filed: Nov. 4, 2020

(51) Int. Cl. A01K 15/02

(52) U.S. Cl. CPC A01K 15/024

(57) ABSTRACT

A scratching post wrap apparatus for easy cleaning or replacement of the scratching surface includes a wrap backing and a scratching nap coupled to the wrap backing. A first engagement member is coupled to the wrap backing. The first engagement member is coupled adjacent a first end of the wrap backing. A second engagement member is coupled to the scratching nap. The second engagement member is coupled to a second end of the scratching nap opposite the first end of the wrap backing. The first engagement member and the second engagement member are selectively engageable to secure the wrap backing around a sidewall of a scratching post.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to scratching post devices and more particularly pertains to a new scratching post device for easy cleaning or replacement of the scratching surface.

### (2) Description of Related Art Including Information Disclosed Under 37 CFR 1.97 and 1.98

The prior art relates to scratching post devices. Known devices include scratching wraps to apply to standard surfaces such as furniture and the like. Known devices also include wrap systems for square posts and flat platforms and the junctions therebetween. These known devices do not allow for the rewrapping of an existing scratching post.

### BRIEF SUMMARY OF THE INVENTION

An embodiment of the disclosure meets the needs presented above by generally comprising a wrap backing and a scratching nap coupled to the wrap backing. A first engagement member is coupled to the wrap backing. The first engagement member is coupled adjacent a first end of the wrap backing. A second engagement member is coupled to the scratching nap. The second engagement member is coupled to a second end of the scratching nap opposite the first end of the wrap backing. The first engagement member and the second engagement member are selectively engageable to secure the wrap backing around a sidewall of a scratching post.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front elevation view of a scratching post wrap apparatus according to an embodiment of the disclosure.

FIG. 2 is a rear elevation view of an embodiment of the disclosure.

FIG. 3 is a top plan view of an embodiment of the disclosure.

FIG. 4 is an isometric view of an embodiment of the disclosure.

FIG. 5 is an isometric view of an embodiment of the disclosure.

FIG. 6 is an isometric view of an embodiment of the disclosure.

### DETAILED DESCRIPTION OF THE INVENTION

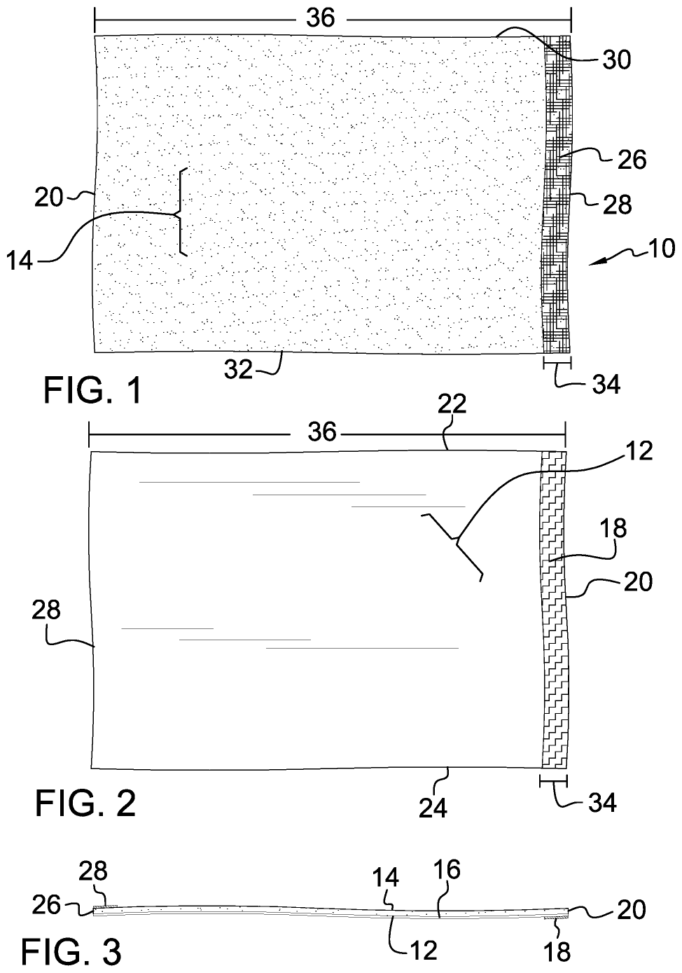

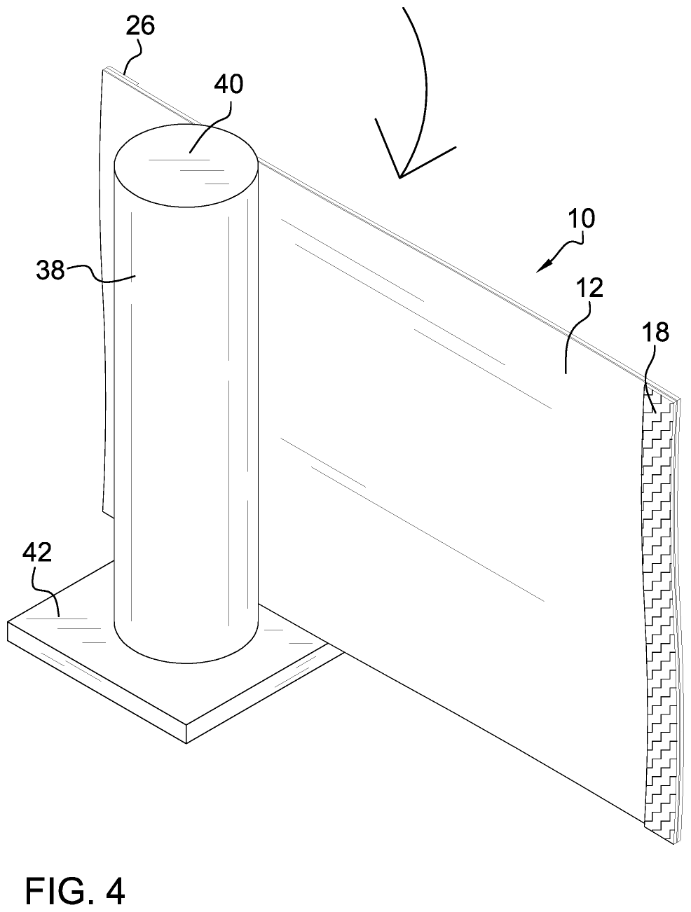

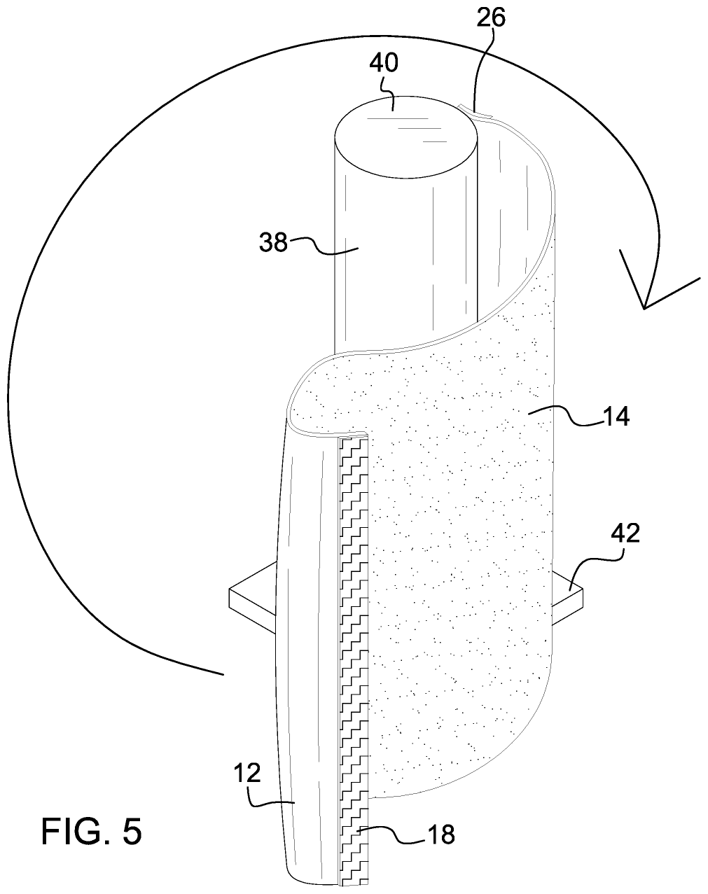

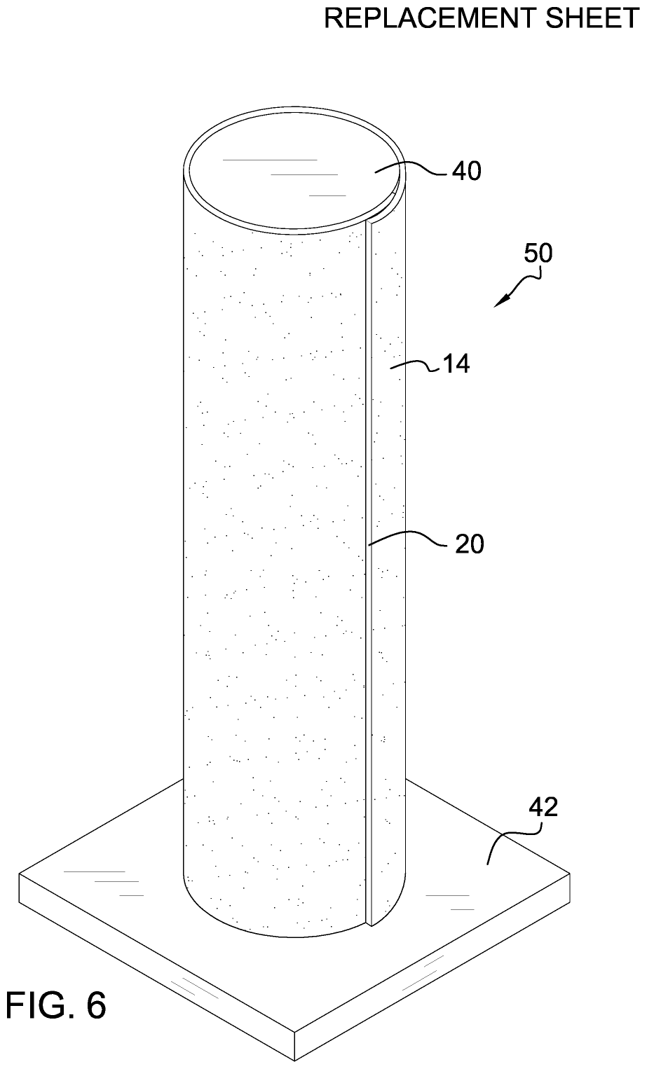

With reference now to the drawings, and in particular to FIGS. 1 through 6 thereof, a new scratching post device embodying the principles and concepts of an embodiment of the disclosure and generally designated by the reference numeral 10 will be described.

As best illustrated in FIGS. 1 through 6, the scratching post wrap apparatus 10 generally comprises a wrap backing 12 and a scratching nap 14 coupled to the wrap backing 12. The scratching nap 14 is continuously coupled to a wrap backing front side 16 of the wrap backing. The scratching nap 14 may be at least twice as thick as the wrap backing 12. The scratching nap 14 may be a carpet material such as, but not limited to, sisal, low pile rug, and the like.

A first engagement member 18 is coupled to the wrap backing 12. The first engagement member 18 is coupled adjacent a first end 20 of the wrap backing. The first engagement member 18 may extend from a backing top edge 22 to a backing bottom edge 24 of the wrap backing.

A second engagement member 26 is coupled to the scratching nap 14. The second engagement member 26 is coupled to a second end 28 of the scratching nap opposite the first end 20 of the wrap backing. The second engagement member 26 may extend from a nap top edge 30 to a nap bottom edge 32 of the scratching nap.

Each of the first engagement member 18 and the second engagement member 26 may be a selectively engageable fastener such as, but not limited to, hook-and-loop fasteners, snaps, adhesives, and the like. An engagement width 34 of each of the first engagement member 18 and the second engagement member 26 may be equal to 10% of a wrap width 36 of the wrap backing 12 and the scratching nap 14. The engagement width 34 and the wrap width 36 may be 2 inches and 20 inches, respectively. The first engagement member 18 and the second engagement member 26 are selectively engageable to secure the wrap backing 12 around a sidewall 38 of a scratching post 40.

The apparatus 10 may be part of a system 50 including the scratching post 40. The scratching post 40 may include a square post base 52 to be freestanding.

In use, the wrap backing 12 is wrapped around a blank or worn scratching post 40 or section thereof and the first engagement member 18 is engaged with the second engagement member 26. When the scratching nap 14 is worn it may then be disengaged and replaced.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A scratching post wrap apparatus comprising:
a wrap backing;
a scratching nap coupled to the wrap backing, the scratching nap being coupled to a wrap backing front side of the wrap backing wherein the scratching nap is exposed continuously on the wrap backing front side and a wrap backing back side is exposed facing away from the scratching nap, the scratching nap being at least twice as thick as the wrap backing;
a first engagement member coupled to the wrap backing, the first engagement member being coupled adjacent a first end of the wrap backing; and
a second engagement member coupled to the scratching nap, the second engagement member being coupled to a second end of the scratching nap opposite the first end of the wrap backing, the first engagement member and the second engagement member being selectively engageable to secure the wrap backing around a sidewall of a scratching post.

2. (canceled)

3. The scratching post wrap apparatus of claim 1 further comprising the first engagement member extending from a backing top edge to a backing bottom edge of the wrap backing; the second engagement member extending from a nap top edge to a nap bottom edge of the scratching nap.

4. (canceled)

5. The scratching post wrap apparatus of claim 1 further comprising an engagement width of each of the first engagement member and the second engagement member being equal to 10% of a wrap width of the wrap backing and the scratching nap.

6. A scratching post wrap apparatus comprising:
a wrap backing;
a scratching nap coupled to the wrap backing, the scratching nap being coupled to a wrap backing front side of the wrap backing wherein the scratching nap is exposed continuously on the wrap backing front side and a wrap backing back side is exposed facing away from the scratching nap, the scratching nap being at least twice as thick as the wrap backing;
a first engagement member coupled to the wrap backing, the first engagement member being coupled adjacent a first end of the wrap backing, the first engagement member extending from a backing top edge to a backing bottom edge of the wrap backing; and
a second engagement member coupled to the scratching nap, the second engagement member being coupled to a second end of the scratching nap opposite the first end of the wrap backing, the second engagement member extending from a nap top edge to a nap bottom edge of the scratching nap, an engagement width of each of the first engagement member and the second engagement member being equal to 10% of a wrap width of the wrap backing and the scratching nap, the first engagement member and the second engagement member being selectively engageable to secure the wrap backing around a sidewall of a scratching post.

7. A scratching post wrap apparatus and scratching post system comprising:
a scratching post, the scratching post having a sidewall;
a wrap backing;
a scratching nap coupled to the wrap backing, the scratching nap being coupled to a wrap backing front side of the wrap backing wherein the scratching nap is exposed continuously on the wrap backing front side and a wrap backing back side is exposed facing away from the scratching nap, the scratching nap being at least twice as thick as the wrap backing;
a first engagement member coupled to the wrap backing, the first engagement member being coupled adjacent a first end of the wrap backing, the first engagement member extending from a backing top edge to a backing bottom edge of the wrap backing; and
a second engagement member coupled to the scratching nap, the second engagement member being coupled to a second end of the scratching nap opposite the first end of the wrap backing, the second engagement member extending from a nap top edge to a nap bottom edge of the scratching nap, an engagement width of each of the first engagement member and the second engagement member being equal to 10% of a wrap width of the wrap backing and the scratching nap, the first engagement member and the second engagement member being selectively engageable to secure the wrap backing around the sidewall of the scratching post.

8. The scratching post wrap apparatus of claim 7 further comprising the scratching post having a square post base.
